(19) United States
(12) Patent Application Publication
(10) Pub. No.: US 2026/0178999 A1
(43) Pub. Date: Jun. 25, 2026

(54) WETLAND RESTORATION METHOD BASED ON "ECOLOGICAL LEVERAGE POINTS"

(71) Applicant: Institute of Ecological Conservation and Restoration, Chinese Academy of Forestry, Beijing (CN)

(72) Inventors: Lijuan CUI, Beijing (CN); Rumiao WANG, Beijing (CN); Jing LI, Beijing (CN); Manyin ZHANG, Beijing (CN); Wei LI, Beijing (CN)

(73) Assignee: Institute of Ecological Conservation and Restoration, Chinese Academy of Forestry, Beijing (CN)

(21) Appl. No.: 19/218,685

(22) Filed: May 27, 2025

(30) Foreign Application Priority Data
Dec. 20, 2024 (CN) 202411896128.0

(51) Int. Cl. A01G 22/00; A01G 17/00

(52) U.S. Cl. CPC G06Q 10/06; A01G 17/005

(57) ABSTRACT

A wetland restoration method based on an “ecological leverage points” is provided. The wetland restoration method includes the following steps: S1, selecting suitable native pioneer plants, and selecting a region for establishing restoration points in a degraded wetland; S2, calculating to obtain an expected plant population quantity Pₚᵣₒ of the degraded wetland according to the area S of the degraded wetland and the set expected planting density ρₚᵣₑ in combination with the following formula III, setting restoration time t, then calculating to obtain an initial plant population quantity P₀ at t=0 by adopting the following formulas I and II, and further calculating to obtain the initial planting area S₀ according to the initial plant population quantity P₀ and the expected planting density ρₚᵣₑ;

$$\frac{\partial P}{\partial t} = rP \frac{N}{N + k} - aP ; \qquad formula I$$

$$\frac{\partial N}{\partial t} = A - bP + acP ; \qquad formula II$$

$$and$$

$$S = P / ρ . \qquad formula III$$

### CROSS REFERENCE TO THE RELATED APPLICATIONS

This application is based upon and claims priority to Chinese Patent Application No. 202411896128.0, filed on Dec. 20, 2024, the entire contents of which are incorporated herein by reference.

### TECHNICAL FIELD

The present invention belongs to the technical field of wetland restoration, in particular to a wetland restoration method based on “ecological leverage points”.

### BACKGROUND

Wetlands, known as the “kidney of the earth”, are one of the most diverse ecosystems on the earth. They not only provide habitats and breeding sites for countless species, but also play an irreplaceable role in regulating climate, purifying water quality, controlling floods, maintaining biodiversity and the like. However, with population growth, accelerated urbanization, and the influence of natural factors such as climate change, the global wetland ecosystem is suffering unprecedented destruction, the area is sharply decreased, the biodiversity is sharply reduced, and the ecological service function is seriously degraded. In response to wetland degradation and loss of biodiversity and ecosystem services, wetland restoration actions have been carried out globally. Comprehensive restoration of large areas of damaged wetlands requires huge financial, human and technical support, which is a heavy economic burden for many countries and regions.

### SUMMARY

In order to solve the technical problems of low restoration efficiency, resource waste and the like in the prior art of this field, the present invention provides a wetland restoration method based on “ecological leverage points”.

The technical scheme of the present invention is as follows.

A wetland restoration method based on “ecological leverage points”, including the following steps:
S1: selecting suitable native pioneer plants, and selecting a region for establishing restoration points in a degraded wetland; and
S2: calculating to obtain an expected plant population quantity Pₚᵣₒ of the degraded wetland according to an area S of the degraded wetland and a set expected planting density ρₚᵣₑ and in combination with the following formula III, setting restoration time t, then calculating to obtain an initial plant population quantity P₀ at t=0 by adopting the following formulas I and II, and further calculating to obtain an initial planting area S₀ according to the initial plant population quantity P₀ and the expected planting density ρₚᵣₑ.

$$\frac{\partial P}{\partial t} = rP \frac{N}{N + k} - aP \qquad formula I$$

$$\frac{\partial N}{\partial t} = A - bP + acP \qquad formula II$$

$$S = P / ρ \qquad formula III$$

wherein P is the plant population quantity; t is the restoration time; r is a maximum plant growth rate; N is a soil nutrient index;
k is a soil nutrient index corresponding to half of the maximum plant growth rate r;
a is a plant mortality rate; A is an exogenous nutrient input rate; b is a nutrient absorbed from soil by plants during growth; c is a nutrient input into soil by each dead plant; S is the planting area; and ρ is the planting density.

The wetland restoration points refer to regions where the pioneer plants overcome environmental stress and are successfully colonized.

The wetland restoration method based on “ecological leverage points”, further including the following step: S3, manually planting the pioneer plants in the selected region for establishing the restoration points according to the calculated initial planting area S₀ to establish primary restoration points.

The expected planting density ρₚᵣₑ is determined according to a method recorded in an article titled “Clonal Growth Adaption of Carex brevicuspis to Sediment Deposition in Dongting Lake Wetland”.

In S1, selecting suitable native pioneer plants refers to selecting pioneer plants according to a method recorded in an article titled “Study on Niche and Interspecific Linkage of Dominant Herbaceous Plants in the Middle and Lower Reaches of the Yellow River wetlands in Henan”.

In S1, selecting a region for establishing restoration points in a degraded wetland refers to selecting according to a method recorded in an article titled “Suitability Evaluation of Wetland Restoration in Sanjiang Plain”. More specially, selecting a region for establishing restoration points in a degraded wetland refers to selecting a region with a gradient of less than 10°, a field water retention capacity of more than 15%, a pH value of 6.5-8.5, soil total nitrogen of more than 500 mg/kg, total phosphorus of more than 300 mg/kg, total potassium of more than 5 g/kg and soil organic matter content of more than 6 g/kg as a region for establishing restoration points.

Driving refers to driving comprehensive restoration of the wetland in an ecological self-organizing manner with plant diffusion and plant-soil feedback as driving forces.

Invasive plants are removed before S1; and preferably, the invasive plants include Spartina alterniflora, Sonneratia apetala, and Laguncularia racemosa.

The wetland refers to a degraded wetland, a wetland to be restored, or an unrestored wetland.

The pioneer plants are selected from Sesuvium portulacastrum, Suaeda salsa, Phragmites australis, Scirpus mariqueter, Carex scabrifolia, Tamarix chinensis, Avicennia marina, and Aegiceras corniculatum.

The present invention has the beneficial effects as follows.

The core innovation of the present invention is that the final expected plant population quantity Pₚᵣₒ and the initial plant population quantity P₀ of the wetland may be obtained according to the initial data and preset data of the wetland restoration project, for example, the area of the degraded wetland to be restored, the expected planting density, the restoration time required by the restoration project, and the like, then the initial planting density ρ₀ of the pioneer plants is further calculated, the pioneer plants are planted on the actual wetland according to the initial planting density ρ₀, which is equivalent to obtaining the final expected plant population quantity of the degraded wetland, after restoration points are established through soil moisture and nutrient improvement and colonization of native plants, the plants absorb soil nutrients to increase the population quantity, and the plants release nutrient substances to the soil through root metabolism and residue decomposition, which further promotes the growth and diffusion of the plants, and then drives the restoration of wetland vegetation in the whole region. In this system, the plant population quantity and the soil nutrients promote and restrict each other. The restoration method of the present invention can realize the comprehensive restoration of the whole wetland within the time required by the project, saves more than 90% of the planting engineering quantity compared with the conventional vegetation planting restoration method, is efficient and economical, and is suitable for popularization in various wetland restoration projects.

Based on the dynamic characteristics and dynamic rules of the wetland ecosystem, the present invention integrates the ecosystem complexity theory and innovatively provides an “ecological leverage points” restoration method, namely, a small-area wetland unit is first established in the degraded wetland, and then core ecological processes such as biological population growth, space diffusion, and biogeomorphic feedback are utilized to realize the economic and efficient comprehensive restoration of the whole ecosystem.

### BRIEF DESCRIPTION OF THE DRAWINGS

FIG. 1 is a satellite diagram before wetland restoration according to Experimental Example 1 of the present invention;

FIG. 2 is a satellite diagram of a wetland in the fourth year of implementing a restoration method of the present invention, showing that the wetland has been comprehensively restored according to Experimental Example 1 of the present invention;

FIG. 3 is an effect diagram of a process of actual restoration of a wetland by a restoration method of the present invention according to Experimental Example 1 of the present invention;

FIG. 4 is an on-site state diagram of a wetland after removal of invasive plants according to Experimental Example 2 of the present invention;

FIG. 5 is an on-site state diagram of a wetland after restoration points are established by a restoration method of the present invention according to Experimental Example 2 of the present invention; and

FIG. 6 is an on-site state diagram of a wetland after comprehensive restoration is realized by a restoration method of the present invention according to an Experimental Example 2 of the present invention.

### DETAILED DESCRIPTION OF THE EMBODIMENTS

The specific content of the present invention will be further described in detail below in combination with specific examples, accompanying drawings and experimental examples, but the scope of protection the present invention is not limited thereby.

The present invention provides a wetland restoration method based on “ecological leverage points”. All the examples of the present invention have the following common characteristics: the wetland restoration method based on “ecological leverage points” includes the following steps:
S1: selecting suitable native pioneer plants, and selecting a region for establishing restoration points in a degraded wetland; and
S2: calculating to obtain an expected plant population quantity Pₚᵣₒ of the degraded wetland according to an area S of the degraded wetland and a set expected planting density ρₚᵣₑ and in combination with the following formula III, setting restoration time t, then calculating to obtain an initial plant population quantity P₀ at t=0 by adopting the following formulas I and II, and further calculating to obtain an initial planting area S₀ according to the initial plant population quantity P₀ and the expected planting density ρₚᵣₑ,

$$\frac{\partial P}{\partial t} = rP \frac{N}{N + k} - aP \qquad formula I$$

$$\frac{\partial N}{\partial t} = A - bP + acP \qquad formula II$$

$$S = P / ρ \qquad formula III$$

wherein P is the plant population quantity; t is the restoration time; r is a maximum plant growth rate; N is a soil nutrient index;
k is a soil nutrient index corresponding to half of the maximum plant growth rate r;
a is a plant mortality rate; A is an exogenous nutrient input rate; b is a nutrient absorbed from soil by plants during growth; c is a nutrient input into soil by each dead plant; S is the planting area; and p is the planting density.

In a specific example, the wetland restoration points refer to regions where the pioneer plants overcome environmental stress and are successfully colonized.

In a further example, the wetland restoration method based on “ecological leverage points” further includes the following step: S3: manually planting the pioneer plants in the selected region for establishing the restoration points according to the calculated initial planting area S₀ to establish primary restoration points.

In this way, based on the established restoration points, the feedback process between plants and soil nutrients is used as a driving force to drive the degraded wetland to realize comprehensive restoration.

In some examples, the expected planting density ρₚᵣₑ is determined according to a method recorded in an article titled “Clonal Growth Adaption of Carex brevicuspis to Sediment Deposition in Dongting Lake Wetland”.

In some specific examples, the determination and setting of the value of the expected planting density ρₚᵣₑ are a conventional technical means well known to those skilled in the art, specifically referring to the determination of the expected planting density by conducting a field investigation in a natural ecosystem similar to the climate conditions and the expected vegetation restoration targets (pioneer plants) of the degraded wetland project site, and combining the methods recorded in the above literatures. For example, a plurality of small quadrats are selected in the natural ecosystem similar to the climate conditions and the expected vegetation restoration targets (pioneer plants) of the degraded wetland project site, the number of plant individuals in each small quadrat is marked and the area of each corresponding small quadrat is measured, and the number of plant individuals in each small quadrat is divided by the area of each corresponding small quadrat to obtain a quotient value; and the expected planting density ρₚᵣₑ of the pioneer plants may be determined by averaging the quotient values of the small quadrats.

P (dimension: plant) is the plant population quantity, which has a conventional technical meaning generally understood by those skilled in the art, and may be the meaning of “plant population quantity” recorded in an article titled “Investigation and Analysis of Grassland Plant Resources in Taiyue Mountain in the North of China”; and

N (dimension: mg/kg) is the soil nutrient index, which has a conventional technical meaning generally understood by those skilled in the art, for example, it may be the meaning of “soil nutrient index” recorded in an article titled “Grey correlation analysis of water conservation function of typical vegetation types in the alpine region of the Qilian Mountains”.

t (dimension: d) is the restoration time. At the beginning of the wetland restoration project, the restoration time t is determined according to the requirements of the project.

The initial soil nutrient N₀ is obtained through on-site investigation and soil analysis at the initial stage of restoration. The contents of soil organic carbon, nitrogen, phosphorus, potassium and other nutrients are measured by the methods recorded in the book “Soil and Agricultural Chemistry Analysis”, and then averaged to obtain a comprehensive value. See “Technical Guideline for Regional Ecosystem Stability Evaluation” for the specific algorithm.

The maximum plant growth rate r (dimension: %/d) in the restoration region (referring to the whole degraded wetland region) has a conventional technical meaning generally understood by those skilled in the art, specifically referring to the increase rate of the plant population quantity in the restoration region. By carrying out a local planting test on specific plants adopted for wetland restoration, the proportion of the number of plant individuals that have increased within per unit time to the number of initial plants is calculated, which is defined as the r value;

The k (dimension: mg/kg) is the soil nutrient index corresponding to half of the maximum plant growth rate, has a conventional technical meaning generally understood by those skilled in the art, and may be obtained by carrying out a potted cultivation planting test on plants adopted for wetland restoration in combination with a method recorded in an article titled “Dynamics Features of Nutrients Absorption for the Growth of Water-Blooming Cyanobacteria in Qingcaosha Reservoir”;

$$\frac{N}{N + k}$$

is a constant ranging between 0 and 1, when the N value and the K value are determined, the value of the constant may be determined, when N is greater than K,

$$\frac{N}{N + k} \approx 1 ,$$

showing that the growth of the plant is not limited by nutrients, when N is less than K,

$$\frac{N}{N + k} \approx 0 ,$$

showing that the growth of the plant is limited by the lack of nutrients, when N is equal to K,

$$\frac{N}{N + k} = \frac{1}{2} ,$$

showing that the growth rate of the plant is half of the maximum rate, and

$$\frac{N}{N + k}$$

reflects the regulation of soil nutrients on plant growth, and describes the mutual promotion and restriction relationship between plant population quantity and soil nutrients, and the completion of vegetation restoration is realized within the expected time by controlling the parameters in the equation;
the a (dimension: %/d) is the plant mortality rate, and the proportion of the dead plant individuals to all the plants within per unit time is counted by carrying out a local planting test on the specific plants adopted for wetland restoration; and
the A (dimension: mg/kg/d) is the exogenous nutrient input rate, which refers to the rate of nitrogen, phosphorus and potassium fertilizers artificially input during the restoration. The calculation method is: artificial input quantity/soil quantity/time. The artificial input quantity is a comprehensive value. See the “National Ecological Environment Standard of the People's Republic of China for the calculation method” for the calculation method.

The b (dimension: mg/plant/d) is the nutrition absorbed from the soil by plants during growth, which is obtained by carrying out a local planting test on specific plants adopted for wetland restoration, vermiculite is used as a substrate in a potted experiment, the target plants are planted, the contents of nutrient substances such as organic carbon, nitrogen, phosphorus, and potassium increased in the substrate within per unit time is counted, and the increase of a soil nutrient index is calculated, which may be measured by the method recorded in the “National Ecological Environment Standard of the People's Republic of China”; and the soil nutrient index is an environmental concept, and its source is the “National Ecological Environment Standard of the People's Republic of China”.

The c (dimension: mg/plant) is the nutrient input into the soil by each dead plant, which is obtained by carrying out a potted planting test on specific plants adopted for wetland restoration. For specific details, please refer to a method described in an article titled “Effects of Litter Additions on Soil Carbon, Nitrogen and Phosphorus Contents and Their Stoichiometric Characteristics in Sagebrush Desert Grassland”.

In a specific example of the present invention, the following terms have the following definitions.

Ecological leverage points: large-scale near-natural restoration is triggered by implementing manual intervention within a small scope.

Near-natural restoration has a conventional technical meaning well known to those skilled in the field of wetland technology, for example, it may be the meaning of the term “near-natural restoration” recorded in an article titled “Near-natural Precise Restoration of Degraded Ecosystems: Nature-based Solutions”.

Restoration points: Before the restoration process begins, small-area wetland vegetation units are first restored to start the positive feedback process of the ecosystem, thereby driving the self-restoration of the ecosystem. These initially established small-area wetland units are the restoration points.

The above control method f for the wetland restoration process based on the “ecological leverage points” plays a positive role in the completion of the establishment of the restoration points and the comprehensive restoration of the whole wetland, and reduces the cost of the wetland restoration engineering on the premise of ensuring the same restoration effect through moderate positive intervention. The above control method plays a role through the positive feedback among various elements in the ecosystem, and regions with relatively flat terrain, less external disturbance, good water retention capacity of soil and good ecological connectivity with the surrounding environment are usually selected as potential restoration points; a suitable environment is created through soil improvement, hydrological regulation and other measures to stimulate a soil seed bank, and propagules such as seeds or seedling of pioneer plants cross a survival threshold in a suitable microenvironment, are quickly fixed through rapid growth of root systems, and are expanded through cloning or seed propagation after colonization; the aboveground parts of pioneer plants help to reduce the loss of soil moisture, slow down the surface runoff rate and accelerate the deposition; the developed underground rhizome system helps to improve the soil structure and strengthen the soil water retention capacity; and meanwhile, soil microorganisms quickly respond to the changes in the soil environment caused by the expansion of aboveground plants, help to decompose organic matters and accelerate the nutrient cycle, and increase the accumulation and deposition of soil nutrients.

Meanwhile, the above control method of the present invention first restores the wetland with the area which does not exceed 50% of the total area in the degraded wetland, and gradually realizes self-restoration through the spontaneous interaction of various elements such as plants, soil, water, animals, and microorganisms in the ecosystem, so that this method is different from the traditional wetland restoration method that the construction is carried out in the whole region, thereby obviously reducing the cost and realizing the resource saving.

In the specific example, in S1, selecting suitable native pioneer plants refers to selecting pioneer plants according to a method recorded in an article “Study on Niche and Interspecific Linkage of Dominant Herbaceous Plants in the Middle and Lower Reaches of the Yellow River wetlands in Henan”.

In some examples, the pioneer plant has a conventional technical meaning well known to those skilled in the art, for example, it can be the meaning of “pioneer plant” recorded in an article titled “Study on Niche and Interspecific Linkage of Dominant Herbaceous Plants in the Middle and Lower Reaches of the Yellow River wetlands in Henan”. Selecting suitable native pioneer plants specifically refers to obtaining the candidate native pioneer plants by consulting the Local Flora and Natural Resource Survey Report, and then, selecting one native pioneer plant having the strongest reproductive ability and the greatest tolerance to poor soil nutrients according to the reproductive ability and the tolerance to poor soil nutrients of each native pioneer plant. Selection according to the reproductive ability and tolerance to poor soil nutrients of each native pioneer plant is a conventional technical means well known to those skilled in the art, and can be specifically determined by consulting the records in the literature. For example, in Experimental Example 1 of the present invention, the candidate native pioneer plants obtained by consulting the Local Flora and Natural Resource Survey Report include: Sesuvium portulacastrum, Phragmites australis, Cyperus malaccensis, and Cyperus malaccensis Lam. var. brevifolius Bocklr., and then, by consulting the records in the literature, it was determined that among these candidate native pioneer plants, Sesuvium portulacastrum has the strongest reproductive ability and the greatest tolerance to poor soil nutrients. Therefore, Sesuvium portulacastrum is selected as the suitable native pioneer plant.

In other examples, in S1, selecting a region for establishing restoration points in a degraded wetland refers to selecting according to a method recorded in an article titled “Suitability Evaluation of Wetland Restoration in Sanjiang Plain”. Specifically, a region with a gradient of less than 10°, a field water capacity of more than 15%, a pH value of 6.5-8.5, soil total nitrogen of more than 500 mg/kg, total phosphorus of more than 300 mg/kg, total potassium of more than 5 g/kg and soil organic matter content of more than 6 g/kg is selected as a region for establishing restoration points.

In a specific example, driving refers to driving comprehensive restoration of the wetland in an ecological self-organizing manner with plant diffusion and plant-soil feedback as driving forces.

The ecological self-organizing has a conventional technical meaning well known to those skilled in the art, and is the meaning of the term “ecological self-organizing” recorded in an article titled “More than the sum of its parts: Self-organized patterns and emergent properties of ecosystem”.

In a more specific example, invasive plants are removed before S1; and

preferably, the invasive plants include Spartina alterniflora, Sonneratia apetala, and Laguncularia racemosa.

In a specific example, the wetland refers to a degraded wetland, a wetland to be restored, or an unrestored wetland.

In a preferred example, the pioneer plants are selected from Sesuvium portulacastrum, Suaeda salsa, Phragmites australis, Scirpus mariqueter, Carex scabrifolia, Tamarix chinensis, Avicennia marina, and Aegiceras corniculatum.

### Example 1: Case of Coastal Wetland Restoration in Shanwei, Guangdong Province

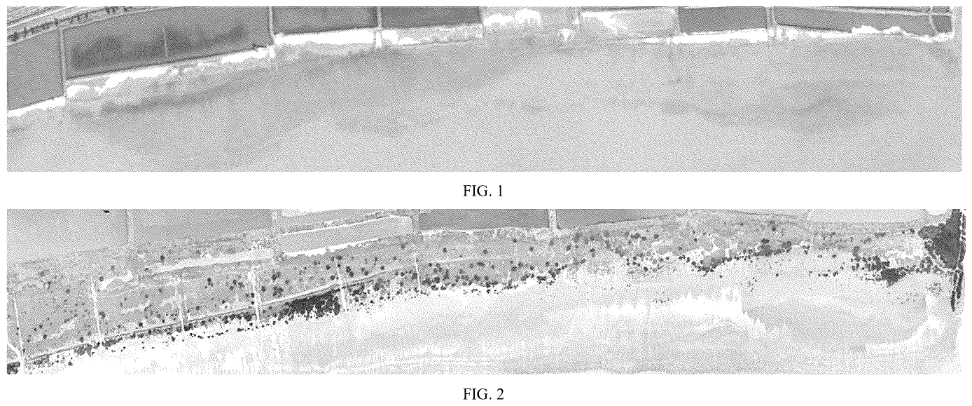

A specific implementation case of the present invention is located in Shanwei, Guangdong Province, with an area of about 7 million m². The state of the wetland before restoration is shown in FIG. 1. In 2019, the background conditions were investigated at the initial stage of coastal wetland restoration, and Sesuvium portulacastrum was clearly adopted as a pioneer species for vegetation restoration. The project is expected to realize comprehensive vegetation coverage within 4 years. According to the planned density of 10 plants/m², it is estimated that there will be a total of 70 million Sesuvium portulacastrum upon the completion of the project. Small-scale field experiments were conducted in degraded wetlands to determine the parameters in the equation (Table 1).

TABLE 1
Parameters in the case of coastal wetland
restoration in Shanwei, Guangdong Province

| | | Measured or | |
|---|---|---|---|
| Parameter | Meaning | calculated values | |
| r | Plant growth rate | 0.35%/d | |
| k | Half-saturated nutrient concentration | 620 | mg/kg |
| | corresponding to maximum plant | | |
| | growth rate | | |
| a | Plant mortality rate | 0.1%/d | |
| b | Nutrients absorbed from the soil by | 0.1 | mg/plant/d |
| | plants during growth | | |
| c | Nutrient input into the soil by each | 1.0 | mg/plant |
| | dead plant | | |
| A | Exogenous nutrient input rate | 0.5 | mg/kg/d |

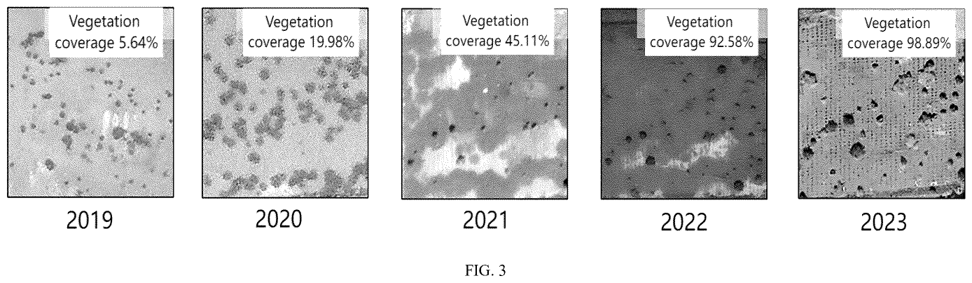

After determining the parameters, the restoration process is simulated in Python. According to the degraded wetland area S=7,000,000 m² and the expected planting density ρₚᵣₑ of 10 plants/m² and in combination with formula III, the final expected plant population quantity Pₚᵣₒ is 70,000,000 plants. According to the requirements of the project, the restoration time t=1,200 d is set, and the initial population quantity P₀=3,485,000 plants is calculated by adopting formulas I and II. According to the calculated P₀ and the expected planting density ρₚᵣₑ and in combination with formula III, the initial planting area S₀ at t=0 is 391,300 m² is obtained. Therefore, in 2019, 348,000 m² of Sesuvium portulacastrum were planted according to the 10 plants/m² as the restoration points. By 2023, the wetland in the region has been comprehensively restored (FIG. 2 and FIG. 3). Compared with the conventional vegetation planting restoration, more than 90% of the planting engineering quantity is saved.

### Example 2: Case of Coastal Wetland Restoration in Yancheng, Jiangsu Province

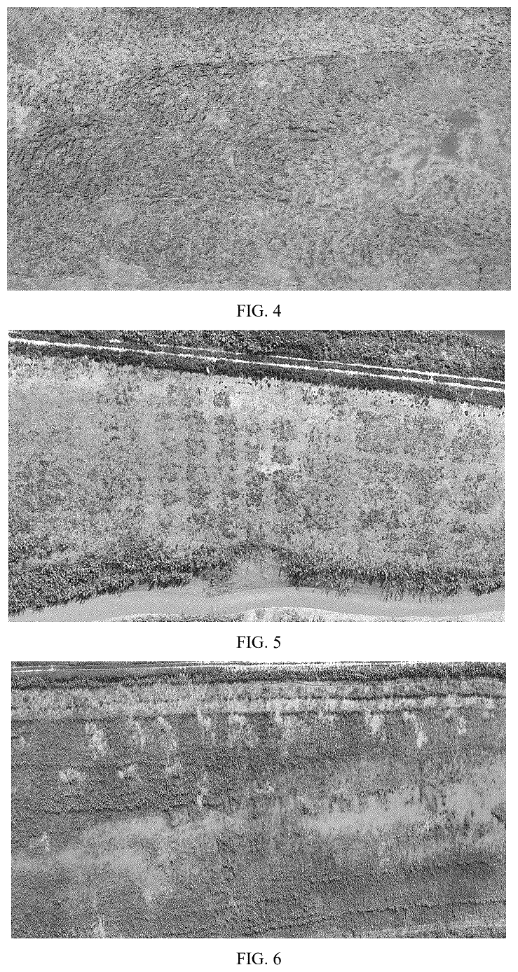

A specific implementation case of the present invention is located in Yancheng Wetland and Rare Birds National Nature Reserve in Jiangsu province, which was originally the Spartina alterniflora invasion region. In 2023, the Spartina alterniflora was removed in the reserve, and the state after removal is shown in FIG. 4, with a total area of 20,000 m². The marsh plant Phragmites australis was used as a pioneer plant to carry out small-field field experiments in degraded wetlands to determine the parameters in the equation (Table 2). As Spartina alterniflora is easy to grow again after removal, it is necessary to quickly restore the Phragmites australis vegetation. The project plans to realize comprehensive coverage of Phragmites australis within 1 year. According to the planned density of 30 plants/m², it is estimated that there will be a total of 600,000 Phragmites australis upon the completion of the project.

TABLE 2
Parameters in the case of coastal wetland
restoration in Yancheng, Jiangsu Province

| | | Measured or | |
|---|---|---|---|
| Parameter | Meaning | calculated values | |
| r | Plant growth rate | 0.31%/d | |
| k | Half-saturated nutrient concentration | 550 | mg/kg |
| | corresponding to maximum plant growth | | |
| | rate | | |
| a | Plant mortality rate | 0.05%/d | |
| b | Nutrients absorbed from the soil by plants | 0.5 | mg/plant/d |
| | during growth | | |
| c | Nutrient input into the soil by each dead | 1.3 | mg/plant |
| | plant | | |
| A | Exogenous nutrient input rate | 0.5 | mg/kg/d |

After determining the parameters, the restoration process is simulated in Python. According to the degraded wetland area S=20,000 m² and the expected planting density ρₚᵣₑ of 30 plants/m² and in combination with formula III, the final expected plant population quantity Pₚᵣₒ is 600,000 plants. According to the requirements of the project, the restoration time t=350 d is set, and the initial population quantity P₀=189,000 plants is calculated by formulas I and II. According to the calculated P₀ and the expected planting density ρₚᵣₑ and in combination with formula III, the initial planting area S₀ at t=0 is 6,300 m² is obtained. Therefore, in May 2023, 6,300 m² of Phragmites australis seedlings were transplanted according to the 30 plants/m² as the restoration points (FIG. 5). By 2024, the wetland in the region has been comprehensively restored (FIG. 6). Compared with the conventional vegetation planting restoration, more than 90% of the planting engineering quantity is saved.

It is apparent that the above examples of the present invention patent are merely examples for clearly illustrating the present invention patent, and are not intended to limit the embodiments of the present invention patent. For those skilled in the art, various other variations and modifications may be made in light of the above description. It is not exhaustive here for all embodiments. Any obvious variations and modifications derived from the technical solution of the present invention patent is still within the scope of protection of the present invention patent.

What is claimed is:

1. A wetland restoration method based on “ecological leverage points”, comprising the following steps:
S1: selecting suitable native pioneer plants, and selecting a region for establishing restoration points in a degraded wetland; and
S2: calculating to obtain an expected plant population quantity Pₚᵣₒ of the degraded wetland according to an area S of the degraded wetland and a set expected planting density ρₚᵣₑ and in combination with the following formula III, setting a restoration time t, then calculating to obtain an initial plant population quantity P₀ at t=0 by adopting the following formulas I and II, and further calculating to obtain an initial planting area S₀ according to the initial plant population quantity P₀ and the set expected planting density ρₚᵣₑ,
$$\frac{\partial P}{\partial t} = rP \frac{N}{N + k} - aP \qquad formula I$$
$$\frac{\partial N}{\partial t} = A - bP + acP \qquad formula II$$
$$S = P / ρ \qquad formula III$$
wherein P is a plant population quantity; t is the restoration time; r is a maximum plant growth rate; N is a soil nutrient index;
k is a soil nutrient index corresponding to half of the maximum plant growth rate r;
a is a plant mortality rate; A is an exogenous nutrient input rate; b is a nutrient absorbed from a soil by plants during growth; c is a nutrient input into the soil by each dead plant; S is a planting area; and ρ is a planting density.

2. The wetland restoration method based on the “ecological leverage points” according to claim 1, wherein the restoration points in a wetland are regions where the suitable native pioneer plants overcome an environmental stress and are successfully colonized.

3. The wetland restoration method based on the “ecological leverage points” according to claim 1, further comprising the following step: S3: manually planting the suitable native pioneer plants in the region for establishing the restoration points according to the initial planting area S₀ to establish primary restoration points.

4. The wetland restoration method based on the “ecological leverage points” according to claim 1, wherein in the step S1, selecting the region for establishing the restoration points in the degraded wetland refers to selecting a region with a gradient of less than 10°, a field water retention capacity of more than 15%, a pH value of 6.5-8.5, soil total nitrogen of more than 500 mg/kg, total phosphorus of more than 300 mg/kg, total potassium of more than 5 g/kg, and a soil organic matter content of more than 6 g/kg as the region for establishing the restoration points.

5. The wetland restoration method based on the “ecological leverage points” according to claim 1, wherein driving refers to driving a comprehensive restoration of a wetland in an ecological self-organizing manner with plant diffusion and plant-soil feedback as driving forces.

6. The wetland restoration method based on the “ecological leverage points” according to claim 1, wherein invasive plants are removed before the step S1,
and/or the invasive plants comprise Spartina alterniflora, Sonneratia apetala, and Laguncularia racemosa.

7. The wetland restoration method based on the “ecological leverage points” according to claim 1, wherein a wetland is the degraded wetland, a wetland to be restored, or an unrestored wetland.

8. The wetland restoration method based on the “ecological leverage points” according to claim 1, wherein the suitable native pioneer plants are selected from Sesuvium portulacastrum, Suaeda salsa, Phragmites australis, Scirpus mariqueter, Carex scabrifolia, Tamarix chinensis, Avicennia marina, and Aegiceras corniculatum.

9. The wetland restoration method based on the “ecological leverage points” according to claim 2, wherein the wetland is the degraded wetland, a wetland to be restored, or an unrestored wetland.

10. The wetland restoration method based on the “ecological leverage points” according to claim 3, wherein a wetland is the degraded wetland, a wetland to be restored, or an unrestored wetland.

11. The wetland restoration method based on the “ecological leverage points” according to claim 4, wherein a wetland is the degraded wetland, a wetland to be restored, or an unrestored wetland.

12. The wetland restoration method based on the “ecological leverage points” according to claim 5, wherein the wetland is the degraded wetland, a wetland to be restored, or an unrestored wetland.

13. The wetland restoration method based on the “ecological leverage points” according to claim 6, wherein a wetland is the degraded wetland, a wetland to be restored, or an unrestored wetland.

14. The wetland restoration method based on the “ecological leverage points” according to claim 2, wherein the suitable native pioneer plants are selected from Sesuvium portulacastrum, Suaeda salsa, Phragmites australis, Scirpus mariqueter, Carex scabrifolia, Tamarix chinensis, Avicennia marina, and Aegiceras corniculatum.

15. The wetland restoration method based on the “ecological leverage points” according to claim 3, wherein the suitable native pioneer plants are selected from Sesuvium portulacastrum, Suaeda salsa, Phragmites australis, Scirpus mariqueter, Carex scabrifolia, Tamarix chinensis, Avicennia marina, and Aegiceras corniculatum.
